(19) United States
(12) Patent Application Publication
(10) Pub. No.: US 2006/0010319 A1
(43) Pub. Date: Jan. 12, 2006

(54) Method of communicating between applications which is intended to secure access to application data

(76) Inventors: Vincent Bonnet, Chevilly-Larue (FR); Serge Piasek, Paris (FR); Lionel Provost, Paris (FR)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 10/523,037

(22) PCT Filed: Aug. 5, 2003
(86) PCT No.: PCT/FR03/02466

§ 371 Date: Jun. 21, 2005

(30) Foreign Application Priority Data
Aug. 6, 2002 (FR) 02/10000

(51) Int. Cl. H04L 9/00

(52) U.S. Cl. 713/164

(57) ABSTRACT

A procedure for communication between at least two applications A and B in an operating system intended to prevent application A from accessing information content of an application window B, including creating at least one variable by application B; receiving a request from application A by application B; verifying a value of the variable by application B to verify validity of the request or of authenticating its origin; and responding to the request as a function of the value and/or the origin.

The present invention pertains to the field of communication between applications within an operating system. In fact, in the standard computer operating systems (Windows™, etc.), the launched applications exchange messages by means of the system in order to obtain information regarding each other.

The present invention therefore has the intention of responding to the problem of confidentiality on the Internet by preventing certain or all applications to have access, e.g., to the user data collected by a navigator.

It is increasing illusory to believe that it is possible to surf the net without being subject to spying. Numerous “free” programs available on the Internet take advantage of the access that the user grants them by installing them for spying on the user's connections and drawing up a consumer profile to be sold. Worse, certain programs have the objective of bringing back to their creators notably passwords, identifiers, credit card numbers and all other types of personal information pertaining to the user. The method used by these spy programs (spyware) is simple: since most of the operating systems are created such that the applications can dialogue with each other, these spyware programs simply demand from the navigator the address of the site or the value of certain fields of a web page (whether or not in Secure Sockets Layer mode) filled out by the user and the navigator provides the spyware with this information.

Already known in the prior art from the American patent U.S. Pat. No. 6,000,032 is a device and a procedure for obtaining a security value which enables a calling module to access in a secure manner a called module in a digital computer. This device makes it possible to grant access to a program module solely upon presentation of a predefined value. However, the problem resolved by this device is the protection of a software program system from hostile attacks while authorizing the identified interlocutors to access the data. The procedure employs relatively complicated calculations intended to determine the rights of the calling module. This invention of the prior art thus does not respond to the same technical problem and the solution that it proposes is too complicated to be implemented for the problem that the present invention intends to resolve.

On the other hand, a known solution consists of developing alternatives to the widely distributed applications in a manner so as to profit from the ignorance of the new applications by the spyware programs. This solution has as principal and fundamental limit that when the alternative becomes known, the developers of the spyware programs integrate it in the list of applications with which they can communicate.

The present invention has the intention of resolving the drawbacks of the prior art by proposing a system using the standard inter-application messages of the operating system in order to implement a control of access to these data by an application.

In order to accomplish this, the present invention is of the type described above and it is remarkable in its broadest sense in that it pertains to a procedure for communication between at least two applications A and B in an operating system intended to prevent application B from accessing the information content of an application window A, characterized in that it comprises the following steps:
a step of creation of at least one variable by application A;
a step of reception of a request from application B by application A;
a step of verification of the value of said variable by application A with the goal of verifying the validity of said request or of authenticating its origin;
a step of response to said request as a function of said value and/or said origin.

In one particular case of the invention, the two applications A and B are the same, i.e., A is equal to B. The procedure then comprises an additional step consisting of modifying the value of the variable for which said request is considered valid.

The verification step is advantageously implemented by an overloaded function of the operating system.

The operating system is preferably Microsoft Windows™ but it can also be any other operating system capable of using/managing messages between applications.

According to one mode of implementation of the invention, said value verified by application A is different from a predefined value and the response step consists of not satisfying said request.

According to another mode of implementation, said value verified by application A is equal to a predefined value and the response step consists of satisfying said request.

Better understanding of the present invention will be obtained from the description below, presented for purely explanatory purposes, of one mode of implementation of the invention with reference to the attached figures:

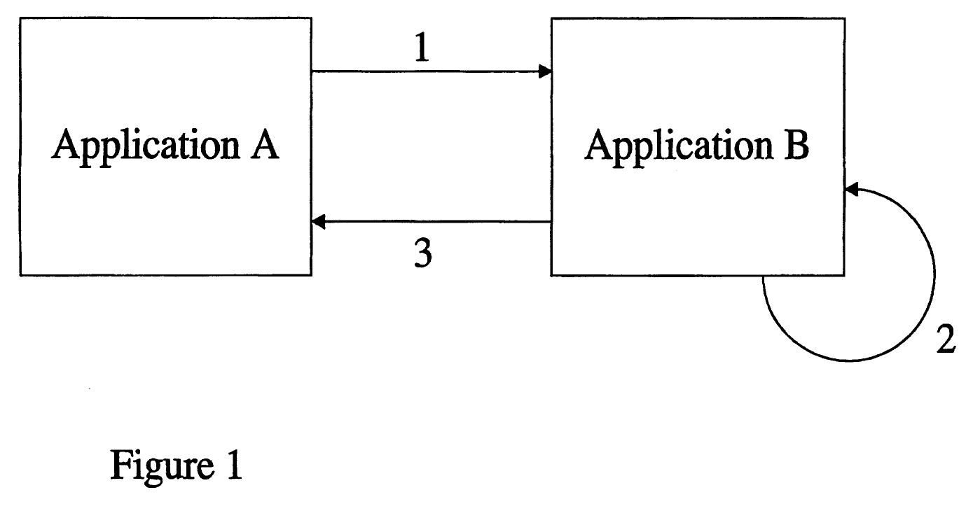

FIG. 1 illustrates the standard process of communication between two applications;

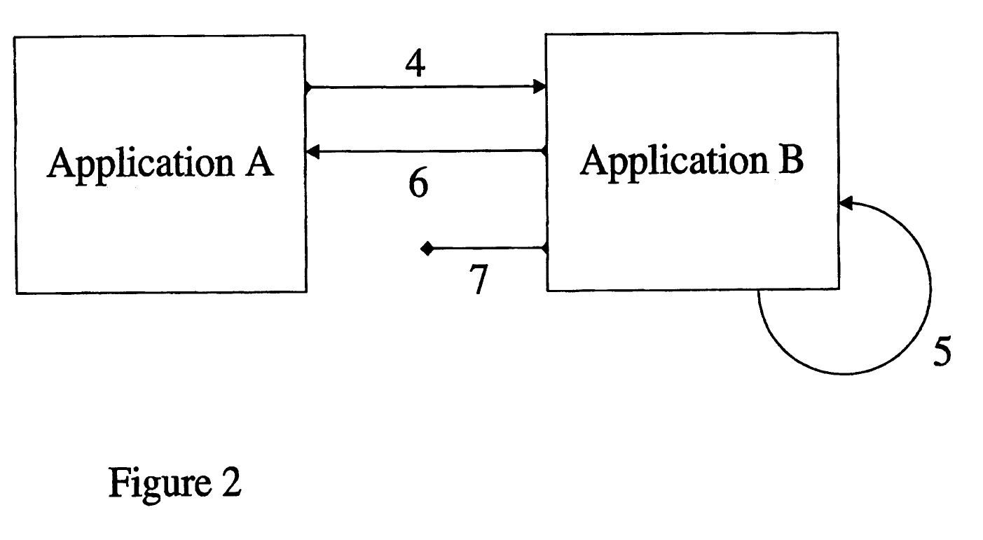

FIG. 2 illustrates the procedure for communication between two applications according to the invention.

According to one preferred mode of implementation of the invention, the invention pertains to the Windows™ operating system in its most widely used versions. In this operating system, an application A, which can be an instant messaging program equipped with a spy program, attempts to recover the value of the URL field of an application window B which can be, e.g., an Internet navigator.

In a standard operating system, the applications communicate according to the procedure described above and illustrated in FIG. 1.

In step (1), an application A addresses a message to an application B in order to obtain information on the elements of application B.

Step (2) consists for application B or one of its internal functions to process the message.

Step (3) is the response of application B to application A by providing the requested information.

In a system comprising an application B equipped with the procedure according to the invention, the communications between another application A and said application B are illustrated in FIG. 2.

In step (4), an application A addresses a message to an application B in order to obtain information on the elements of application B.

Step (5) consists for application B or one of its internal functions of processing the message as a function of the value of a variable internal to application B at the moment of processing of the message.

If the value authorizes that response to the message, application B responds to application A in the same manner as in the standard procedure (step 6).

In the contrary case, application B does not respond to application A but informs the operating system that the message was processed (step 7).

One particular mode of implementation is described below in the Microsoft Windows™ operating system.

An application A desiring to obtain information from an application B generates a “send_message” command with as parameters the message type and the identity of the addressee. If the target application B is a navigator and the application attempts to obtain the content of the URL field of application B, the message type will be CB_GETLBTEXT and the identity of the addressee will be the identifier of the target application window B. This command induces the creation of a variable in the registers of application A intended to collect the response of the targeted application as well as the sending of a message from the operating system containing the address of the register variable and the identity of the addressee.

The operating system receives the message from application A and sends the address of the register variable to the targeted application window B.

Upon creation of the target window, one processing function was attributed to this window intended in particular to process the messages intended for this window. This function is called “DefWindowProc( )” in Microsoft Windows™. The messages are thus arranged in a pile.

For each message of the pile, the processing function reads the message and responds to it by filling out the empty fields of the register of application A created upon the emission of the message by the application. In certain versions of Microsoft Windows™, these fields are called “wparam” and “1param”, and contain on the one hand the length of the response and on the other hand the response. In Microsoft Windows™, if the request consists of obtaining the value of the URL field of the navigator, the processing function of the window will read the value contained for the variable “ComboBoxEx” (corresponding to said URL field) in order to provide the response.

Application A reads the response recorded in these registers then deletes the variable created for this message.

The procedure according to the invention consists of performing the following operations.

Prior to any communication and the launching of target application B, of:
creating and initializing (at 0) a variable of origin in the registers of application B intended to subsequently determine the origin of the incoming messages.
Upon creation of a window, of creating a new processing function similar to that created by default and of overloading this new processing function in order to determine the origin of the incoming messages.

When application B sends a message with itself as addressee, prior to sending the message the origin variable is set at 1.

In all cases, a message with the destination of application window B is first transmitted to the new processing function.

Upon reception of a message, the new processing function first scrutinizes the register containing the origin variable and reads the value of this variable. If this value is equal to 1, the message is transmitted to the standard processing function of the window which terminates the processing according to the procedure described above. If the origin variable is at 0, the message is not processed and application B sends a message to the operating system in order to inform it that the processing of the message is terminated.

The invention was described above as an example. It is understood that the expert in the field could implement different variants of the invention without thereby going beyond the scope of the patent.

1-7. (canceled)

8. A procedure for communication between at least two applications a and b in an operating system intended to prevent application a from accessing information content of an application window b, comprising:
creating at least one variable by application B;
receiving a request from application A by application B;
verifying a value of the variable by application B to verify validity of the request or of authenticating its origin; and
responding to the request as a function of the value and/or the origin.

9. The procedure according to claim 8, wherein the two applications A and B are the same (A is equal to B).

10. The procedure according to claim 9, further comprising modifying the value of the variable for the request to be considered valid.

11. The procedure according to claim 8, wherein verifying is performed by an overloaded function of the operating system.

12. The procedure according to claim 8, wherein the operating system uses and manages messages between applications.

13. The procedure according to claim 8, wherein the value verified by application B is different from a predefined value and responding comprises not satisfying the request.

14. The procedure according to claim 8, wherein the value verified by application B is equal to a predefined value and responding comprises satisfying the request.
